(19) United States
(12) Patent Application Publication
(10) Pub. No.: US 2013/0124772 A1
(43) Pub. Date: May 16, 2013

(54) GRAPHICS PROCESSING

(71) Applicant: NVIDIA Corporation, Santa Clara, CA (US)

(72) Inventors: Wenjie Zheng, Shenzhen (CN); Zhao Sang, Shenzhen (CN)

(73) Assignee: NVIDIA Corporation, Santa Clara, CA (US)

(21) Appl. No.: 13/678,462

(22) Filed: Nov. 15, 2012

(30) Foreign Application Priority Data
Nov. 15, 2011 (CN) 201110360765.2

(51) Int. Cl. G06F 13/40

(52) U.S. Cl. CPC G06F 13/4022
USPC 710/313

(57) ABSTRACT

In one embodiment, a computer system comprises two or more graphics cards, each graphics card comprising: a graphics processing unit and an interface. An interface of the first graphics card is coupled to an interface of the second graphics card for enabling communication between the first and second graphics cards. A cable couples the interface of the first graphics card with the interface of the second graphics card. The transmitting speed of data exchanging between graphics cards of the computer system is increased, and the arrangement of the PCB (printed circuit board) of the graphics card is simple and the cost thereof is low.

### CROSS-REFERENCE TO RELATED APPLICATION

This patent application claims the benefit and priority of the co-pending Chinese Patent Application No. 201110360765.2, filed on Nov. 15, 2011, by Wenjie ZHENG et al., Attorney Docket Number P2011173, which is hereby incorporated by reference in its entirety.

### BACKGROUND

Currently, there is an increasing requirement for the graphics processing capability of electronic equipment, such as desktops, notebooks, workstations and MIDs (Mobile Internet Devices) based on NVIDIA® Tegra® or the like. To fulfill the requirement, a technical solution named “Scalable Link Interface”, “SLI” for short has been developed. SLI is a solution of linking two or more graphics cards to be used as one output, so as to achieve an enhanced graphics processing capability. Specifically, take an example of a solution with two graphics cards; the two graphics cards are connected to each other through the parallel interfaces thereof so as to communicate data with each other. Besides, the two graphics cards are respectively connected to two slots on a mainboard (or motherboard) through their respective other interface (such as Peripheral Component Interconnect Express (PCI Express or PCI-E) interface) to communicate data with the mainboard (or motherboard).

As mentioned above, in the present SLI solution, the graphics cards are connected to each other through parallel interfaces. Each graphics card includes a graphics processing unit (GPU) and a first interface, and two graphics cards communicate data with each other through their first interfaces using a parallel data bus of a plurality of bits, such as 15 bits. The upper layer protocol for the first interface could be DDR protocol. It will be understand that since there are a number of data bits in the parallel interface, and the number of the data lines provided should be equal to the number of the data bits, the cost of the data lines used for the connection between graphics cards is increased. Meanwhile, the arrangement of the PCB (printed circuit board) of the graphics card is more complicated and the cost thereof is increased since there are a number of pins in the interface of the graphics card.

Moreover, the MAX parallel clock is only 400 MHz (megahertz), resulting in a low data transmitting speed.

### SUMMARY

Therefore, there is a need for a graphics card with a PCB (printed circuit board) of simpler arrangement and lower cost, which can achieve a high data transmitting speed between graphics cards so as to decrease the cost of electronic equipment, and meanwhile increase the graphics processing capability thereof.

In order to solve the above-mentioned problems, a computer system, graphics cards thereof and a method for processing graphics of the system are provided in accordance with various embodiments of the present invention, the transmitting speed of data exchanging between graphics cards of the computer system is increased, and the arrangement of the PCB of the graphics card is simple and the cost thereof is low.

In one embodiment of the invention, a graphics card is provided, comprising: a graphics processing unit; and a first interface. The first interface is a SATA (Serial Advanced Technology Attachment) interface used for connecting or coupling to the SATA interface of another graphics card, so that the graphics processing unit of the graphics card is capable of communicating data with another graphics card through the first interface.

Preferably, in an embodiment, the graphics card further comprises a second interface. The second interface is used for connecting or coupling to a mainboard (or motherboard), so that the graphics processing unit is capable of communicating data with the mainboard (or motherboard) through the second interface.

Preferably, in an embodiment, the second interface is a Peripheral Component Interconnect Express (PCI Express or PCI-E) interface.

Preferably, in an embodiment, the SATA interface comprises a data sending pin and a data receiving pin.

Preferably, in an embodiment, the upper layer protocol of the SATA interface is selected from any one of self-defined specific protocol, SATA 1.0 standard protocol, SATA 2.0 standard protocol, and SATA 3.0 standard protocol.

In another embodiment of the invention, a computer system is provided. The system comprises two or more graphics cards, each graphics card comprising: a graphics processing unit; and a first interface. The first interface is a SATA interface, wherein the SATA interface of at least one of the graphics cards is connected or coupled to the SATA interface of another graphics card so that the graphics processing units of the graphics processing cards are capable of communicating data therebetween.

Preferably, in an embodiment, the system further comprises a SATA connection cable, wherein the SATA interface of at least one of the graphics cards is connected or coupled to the SATA interface of another graphics card through a SATA connection (or coupling) cable.

Preferably, in an embodiment, the system further comprises a mainboard (or motherboard), and the mainboard (or motherboard) is provided with a plurality of slots; and each of the graphics cards further comprises a second interface. The second interface is used for connecting or coupling to one of the slots on the mainboard (or motherboard), so that the graphics processing unit of said graphics card is capable of communicating data with the mainboard (or motherboard) through the second interface.

Preferably, in an embodiment, the slots on the mainboard (or motherboard) are PCI-E slots; and each of the second interfaces of the graphics cards is a PCI-E interface.

Preferably, in an embodiment, the system further comprises a central processing unit and a bus. The mainboard (or motherboard) is connected or coupled to the central processing unit through the bus to receive controlling data from the central processing unit and transmit the controlling data to the graphics card.

Preferably, in an embodiment, the SATA interface comprises a data sending pin and a data receiving pin.

Preferably, in an embodiment, the upper layer protocol of the SATA interface of the graphics card is selected from any one of self-defined specific protocol, SATA 1.0 standard protocol, SATA 2.0 standard protocol, and SATA 3.0 standard protocol.

In another embodiment of the invention, a method for processing graphics of a computer system is provided. The computer system comprising a mainboard (or motherboard), two graphics cards provided on the mainboard (or motherboard) and connected or coupled to each other through a SATA connection (or coupling) cable, wherein the method comprises steps of: detecting whether the mainboard (or motherboard) of the system is connected or coupled to both of the graphics cards; allocating graphics processing tasks to be processed to the two graphics cards when the mainboard (or motherboard) of the system is detected to be connected or coupled to both of the graphics cards.

Preferably, in an embodiment, the method further comprises a step of allocating the graphics processing tasks to the single graphics card connected or coupled to the mainboard (or motherboard) when the mainboard (or motherboard) is detected to not be connected or coupled to both of the two graphics cards, during execution of the step of detecting whether the mainboard (or motherboard) of the system is connected or coupled to both of the graphics cards.

Preferably, in an embodiment, the method further comprises a step of: loading the driver for the graphics cards before the step of detecting whether the mainboard (or motherboard) of said system is connected or coupled to both of the graphics cards.

Preferably, in an embodiment, after the step of allocating the graphics processing tasks to be processed to the two graphics cards, the method further comprises steps of: dividing an image to be rendered into two image parts; and rendering the two image parts by the two graphics cards, respectively.

Preferably, in an embodiment, one of the two graphics cards is a master card and the other graphics card is a slave card. And after the step of rendering the two image parts by the two graphics cards, respectively, the method further comprises a step of: sending the rendered image from the slave card to the master card.

Preferably, in an embodiment, after the step of sending the rendered image from the slave card to the master card, the method further comprises a step of: combining the two rendered images by the master card.

Preferably, in an embodiment, after the step of combining the two rendered images by the master card, the method further comprises a step of: outputting and displaying the combined image by the master card.

The following are the effectiveness of various embodiments in accordance with the present invention:

By the technical solution of various embodiments in accordance with the present invention, the data transmitting manner of serial data bus is imported into the SLI technical solution, because the first interface of the graphics card is provided as a SATA interface (Serial Advanced Technology Attachment) and so that the graphics cards could be connected or coupled to each other through the SATA interfaces as well as the SATA connection (or coupling) cable to communicate data with each other in the SLI technical solution. Besides, the serial interface protocol for SLI may be defined as simple as possible. The transmitting speed of serial communication, such as, PCI-E, SATA bus, is high. In an embodiment, only one pair of differential signals can meet the SLI bandwidth requirement.

Furthermore, in an embodiment, only one pair of differential signals, TXD signal and RXD signal are needed in the SATA connection or coupling, which makes the connection or coupling between graphics cards more simple and flexible, and greatly decreases the pins of the interface on the graphics card used for connecting or coupling to other graphics cards, so that the arrangement of the PCB of the graphics card is simplified, the cost of the PCB of the graphics card and accordingly, the cost of computer system comprising the graphics cards are decreased. Besides, in an embodiment, the SATA connection (or coupling) cable is so common and flexible that it is a preferable solution for the connection or coupling between graphics cards in SLI technical solution which is easy to implement. The low-cost feature of the SATA connection (or coupling) cable and the graphics cards of an embodiment of the present invention can promote the development of the SLI technology.

Additional features and advantages of various embodiments in accordance with the present invention will be described in detail in the following description in connection with the accompanying drawings.

While particular embodiments in accordance with the invention have been specifically described within this Summary, it is noted that the invention and the claimed subject matter are not limited in any way by these embodiments.

### BRIEF DESCRIPTION OF THE DRAWINGS

FIG. 1 illustrates a schematic structure diagram of a graphics card in accordance with an embodiment of the present invention;

FIG. 2 illustrates a schematic structure diagram of a computer system comprising graphics cards in accordance with an embodiment of the present invention;

FIG. 3 illustrates a schematic flow diagram of a method for graphics processing of a system in accordance with an embodiment of the present invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

Reference will now be made in detail to preferred embodiments of the present invention, examples of which are illustrated in the accompanying drawings. Those skilled in the art will realize that the following description is illustrative only and is not intended to be in any way limiting.

Various embodiments in accordance with the present invention relate generally to graphics processing technology, in particular, to a computer system, graphics cards thereof and a method for processing graphics of the system.

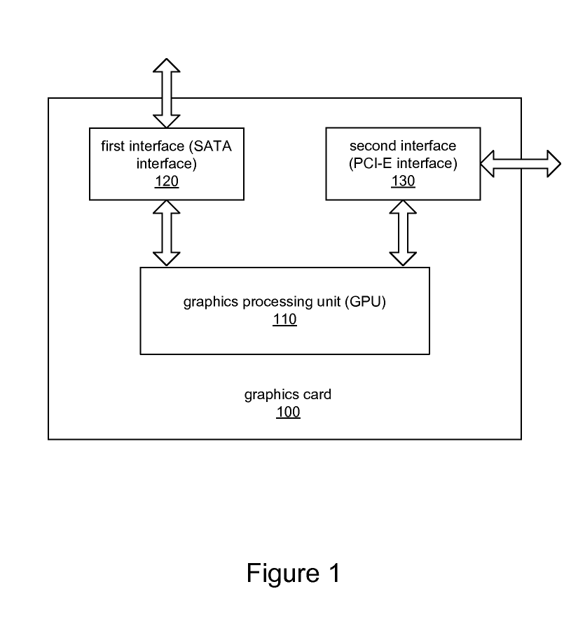

As shown in FIG. 1, a graphics card 100 according to an embodiment of the present invention comprises a graphics processing unit 110 (GPU for short) and a first interface 120. The graphics processing unit 110 may use the GeForce® series of the NVIDIA® Corporation or the HD series of the ATI Corporation, and the like. In an embodiment of the present invention, the first interface is a SATA (Serial Advanced Technology Attachment) interface used for connecting or coupling to a SATA interface of another graphics card which is likewise provided with the SATA interface, so that the graphics processing card 110 is capable of communicating data with another graphics card through the first interface 120.

In an embodiment, it will be understood that since the first interface 120 of the graphics card 100 is a SATA interface, the data communicating between the two graphics cards could be achieved when the respective first interface 120 of each of the graphics cards is connected or coupled to each other through a SATA connection (or coupling) cable in the SLI technical solution. This imports the data transmitting manner of serial data bus into the SLI technical solution. Besides, the serial interface protocol for SLI may be defined as simple as possible. The serial clock of serial communication, such as, PCI-E, SATA bus, is higher than parallel clock, so the transmitting speed of serial communication is higher than that of the parallel communication. In an embodiment, only one pair of differential signals can meet the SLI bandwidth requirement.

Furthermore, in an embodiment, only one pair of differential signals, TXD signal and RXD signal are needed in the SATA connection or coupling, which makes the connection or coupling between graphics cards more simple and flexible, and greatly decreases the pins of the interface 120 on the graphics card 100 used for communicating data with other graphics cards, so that the arrangement of the PCB of the graphics card is simplified and the cost of the PCB of the graphics card is decreased. The low-cost feature of the graphics cards of various embodiments of the present invention can promote the development of the SLI technology.

Preferably, in as shown in FIG. 1, in an embodiment of the present invention, the graphics card 100 further comprises a second interface 130 (e.g., PCI-E interface). The second interface 130 is used for connecting or coupling the graphics card 100 to a mainboard (or motherboard), so that the graphics processing unit 110 is capable of communicating data with the mainboard (or motherboard) through the second interface 130. In the present embodiment, the second interface 130 is a PCI-E interface, while in practice, the second interface 130 could be other suitable interface, such as, PCI (Peripheral Component Interconnect) interface, USB (Universal Serial Bus) interface, and the like as well.

In the present embodiment, the SATA interface comprises a data sending pin and a data receiving pin (not shown in FIG. 1), used respectively for sending and receiving of the above mentioned differential signals, e.g., TXD signal and RXD signal.

Furthermore, preferably, in an embodiment, the upper layer protocol of the SATA interface is selected from any one of SATA 1.0 standard protocol, SATA 2.0 standard protocol, and SATA 3.0 standard protocol. More preferably, in an embodiment, the upper layer protocol of the SATA interface is SATA 3.0 standard protocol. In practice, in an embodiment, the upper layer protocol of the SATA interface could be a self-defined special protocol as well.

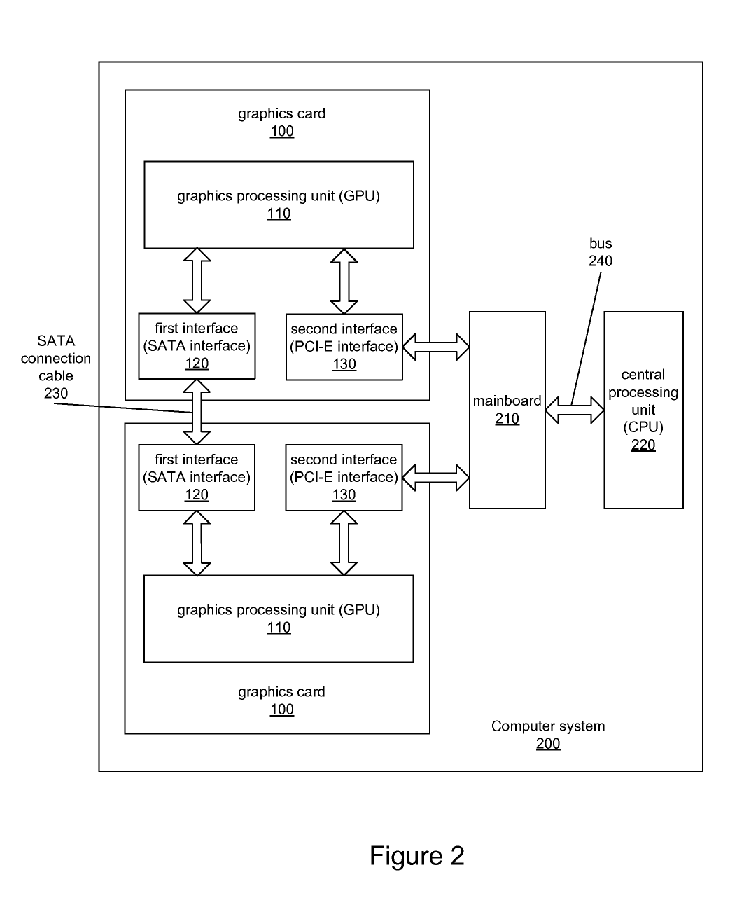

As shown in FIG. 2, a computer system 200 comprising graphics cards is provided in an embodiment in accordance with the present invention as well. The computer system 200 may comprise two or more graphics cards 100, and two graphics cards 100 are present in the present embodiment. Each graphics card 100 comprises a graphics processing unit 110 and a first interface 120. In an embodiment, the first interface 120 is a SATA interface. The SATA interfaces 120 of the two graphics cards 100 are connected or coupled to each other to make sure that the two graphics cards 100 are capable of communicating data therebetween. In an embodiment, during the operating of the computer system 200, the connection or coupling between graphics cards 100 is mainly used for the communicating of the task assignment instructions and the post treated result data.

Preferably, it can further be seen from FIG. 2 that in the present embodiment the computer system 200 further comprises a SATA connection (or coupling) cable 230. The two graphics cards 100 are connected or coupled to each other through the SATA connection cable 230, wherein the two ends of the SATA connection cable 230 are connected or coupled to each SATA interface (first interface 120) of the two graphics cards 100, respectively.

In the manner mentioned above, in an embodiment, the data transmitting manner of serial data bus is imported into the SLI technical solution. Besides, the serial interface protocol for SLI may be defined as simple as possible. The transmitting speed of serial communication, such as, PCI-E, SATA bus, is high. In an embodiment, only one pair of differential signals can meet the SLI bandwidth requirement. Thus, the image processing feature of the computer system 200 is increased.

Furthermore, in an embodiment, only one pair of differential signals, TXD signal and RXD signal are needed in the SATA connection or coupling, which makes the connection or coupling between graphics cards 100 more simple and flexible, and greatly decreases the pins of the first interface 120 on the graphics card 100, so that the arrangement of the PCB of the graphics card 100 is simplified and the cost of the PCB of the graphics card 100 and accordingly, the cost of whole computer system 200 are decreased. Besides, in an embodiment, the SATA connection (or coupling) cable 230 is so common and flexible that it is a preferable solution for the connection or coupling between graphics cards 100 in SLI technical solution which is easy to be implemented. The low-cost feature of the SATA connection cable 230 and the graphics cards 100 of an embodiment in accordance with the present invention can promote the development of the SLI technology.

As shown in FIG. 2, in the present embodiment, the computer system 200 further comprises a mainboard (or motherboard) 210, and the mainboard 210 is provided with a plurality of slots (not shown in FIG. 2); and each of the graphics cards 100 further comprises a second interface 130. The second interface 130 is used for connecting or coupling to one of the slots on the mainboard 210, so that the graphics processing unit 110 of the graphics card 100 is capable of communicating data with the mainboard 210 through the second interface 130. Thus, in an embodiment, during the operating of the computer system 200, a large amount of data which the graphics cards 100 need to call during the rendering process is acquired from the mainboard 210 through the second interface 130.

Preferably, in the present embodiment, the slots on the mainboard 210 are PCI-E slots; and correspondingly, each of the second interfaces of the graphics cards 100 is a PCI-E interface. So the connections or couplings between the mainboard 210 and the graphics cards 100 are PCI-E connection or coupling.

It can further be seen from FIG. 2 that in the present embodiment, the computer system 200 further comprises a central processing unit (CPU) 220 and a bus 240. The above mentioned mainboard (or motherboard) 210 is connected or coupled to the central processing unit 220 through the bus 240 to receive the data which needs to be called during the rendering process from the central processing unit 220 and transmit the data to the graphics card 100.

In the present embodiment, the first interface 120 (e.g., SATA interface) of the graphics card 100 comprises a data sending pin and a data receiving pin (not shown in FIG. 2). Besides, preferably, in an embodiment, the upper layer protocol of the SATA interface of the graphics card 100 is selected from any one of SATA 1.0 standard protocol, SATA 2.0 standard protocol, and SATA 3.0 standard protocol, or otherwise is self-defined special protocol.

Correspondingly, a method for graphics processing of a computer system is further provided in an embodiment in accordance with the present invention, wherein the computer system comprises a mainboard (or motherboard) and two graphics cards provided on the mainboard (or motherboard) and connected or coupled to each other through a SATA connection (or coupling) cable.

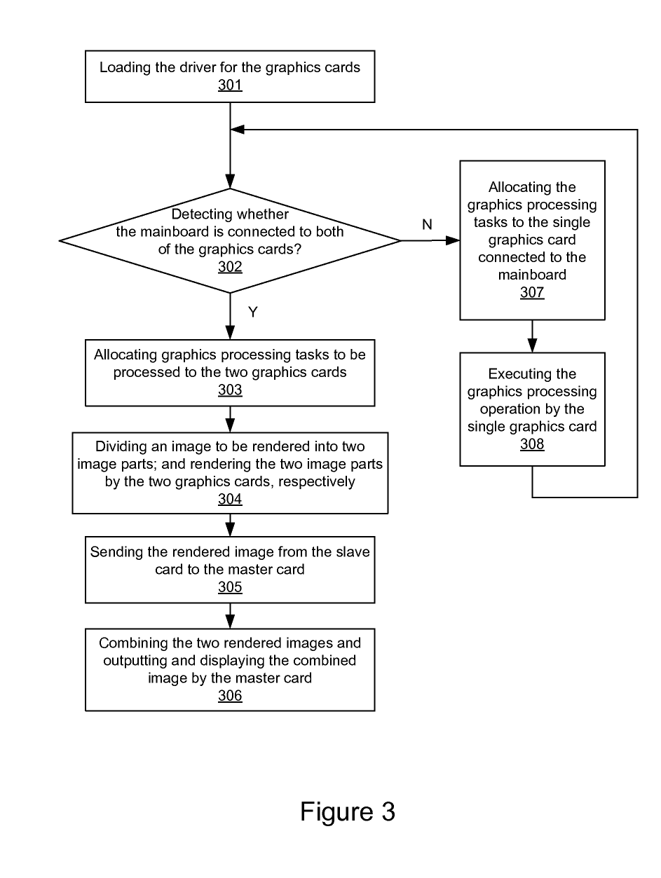

In a preferred embodiment of the method which is seen from FIG. 3, the two graphics cards comprise a master card and a slave card, and the method comprises the following steps:

At 301, loading the driver for the graphics cards.

At 302, detecting whether the mainboard (or motherboard) is connected or coupled to both of the graphics cards. When the mainboard (or motherboard) is detected at step 302 to be connected or coupled to both of the graphics cards, the method proceeds to step 303. Otherwise, the method proceeds to step 307.

At 303, allocating graphics processing tasks to be processed to the two graphics cards.

At 304, dividing an image to be rendered into two image parts; and rendering the two image parts by the two graphics cards, respectively.

At 305, sending the rendered image from the slave card of the two graphics cards to the master card of the two graphics cards.

At 306, combining the two rendered images and then outputting and displaying the combined image by the master card.

At 307, allocating the graphics processing tasks to the single graphics card connected or coupled to the mainboard (or motherboard). It should be noted that step 307 is to be executed when the mainboard (or motherboard) is detected to not be connected or coupled to both of the two graphics cards in step 302, and not to be executed after step 306.

At 308, executing the graphics processing operation by the single graphics card. And after the graphics processing operation by the single graphics card is finished at step 308, the method proceeds to step 302 and continues the step of detecting whether the mainboard (or motherboard) is connected or coupled to both of the graphics cards.

From the above steps, in an embodiment, it will be seen that in this method the computer system comprises two graphics cards connected or coupled to each other through a SATA connection (or coupling) cable, and this imports the data transmitting manner of serial data bus into the SLI technical solution. Besides, the serial interface protocol for SLI may be defined as simple as possible. The serial clock of serial communication, such as, PCI-E, SATA bus, is higher than parallel clock, so the transmitting speed of serial communication is higher than that of the parallel communication. Thus, the efficiency of image processing operation of the whole system is improved.

Certainly, the electronic devices involved in various embodiments in accordance with the present invention can include other known components and future components, which will not be repeated here.

The present invention has been described through the above-mentioned embodiments. However, it will be understood that the above-mentioned embodiments are for the purpose of demonstration and description and not for the purpose of limiting the present invention to the scope of the described embodiments. Moreover, those skilled in the art can appreciated that the present invention is not limited to the above mentioned embodiments and that various modifications and adaptations in accordance of the teaching of the present invention may be made within the scope and spirit of the present invention. The protection scope of the present invention is further defined by the following claims.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A system comprising:
a first graphics card comprising:
a graphics processing unit; and
a first interface coupled to said graphics processing unit; and
a second graphics card comprising a first interface,
said first interface of said second graphics card is coupled with said first interface of said first graphics card for enabling communication between said first and second graphics cards.

2. The system of claim 1, wherein:
said first interface of said first graphics card comprises a Serial Advanced Technology Attachment (SATA) interface; and
said first interface of said second graphics card comprises a SATA interface.

3. The system of claim 1, further comprising:
a cable coupling said first interface of said first graphics card with said first interface of said second graphics card.

4. The system of claim 1, wherein said first graphics card comprising a second interface for coupling to a motherboard, said second interface for enabling said graphics processing unit to communicate with said motherboard.

5. The system of claim 4, wherein said second interface of said first graphics card comprises a Peripheral Component Interconnect Express (PCI-E) interface.

6. A computer system comprising:
a motherboard;
a first graphics card coupled with said motherboard, said first graphics card comprising:
a graphics processing unit; and
a first interface coupled to said graphics processing unit; and
a second graphics card coupled with said motherboard, said second graphics card comprising a first interface,
said first interface of said second graphics card is coupled with said first interface of said first graphics card for enabling communication between said first and second graphics cards.

7. The computer system of claim 6, wherein:
said first interface of said first graphics card comprises a Serial Advanced Technology Attachment (SATA) interface; and
said first interface of said second graphics card comprises a SATA interface.

8. The computer system of claim 7, wherein said SATA interface of said first graphics card comprises a data sending pin and a data receiving pin.

9. The computer system of claim 6, wherein said first graphics card comprising a second interface for coupling to said motherboard, said second interface for enabling said graphics processing unit to communicate with said motherboard.

10. The computer system of claim 9, wherein said second interface of said first graphics card comprises a Peripheral Component Interconnect Express (PCI-E) interface.

11. The computer system of claim 6, further comprising:
a cable coupling said first interface of said first graphics card with said first interface of said second graphics card.

12. The computer system of claim 11, wherein said first graphics card comprising a second interface for coupling to said motherboard, said second interface for enabling said graphics processing unit to communicate with said motherboard.

13. The computer system of claim 6, further comprising:
a bus; and
a central processing unit coupled with said motherboard by said bus.

14. A method comprising:
detecting whether a motherboard is coupled to both a first graphics card and a second graphics card; and
allocating graphics processing tasks to said first and second graphics cards when the motherboard is detected to be coupled to both said first and second graphics cards.

15. The method of claim 14, wherein said first graphics card is coupled with said second graphics card for enabling communication between said first and second graphics cards.

16. The method of claim 15, wherein said first graphics card is coupled with said second graphics card by a cable for enabling communication between said first and second graphics cards.

17. The method of claim 14, further comprising:
allocating said graphics processing tasks to a single graphics card coupled to said motherboard when said motherboard is detected to not be coupled to both of said first and second graphics cards.

18. The method of claim 14, wherein said allocating graphics processing tasks to said first and second graphics cards further comprising:
dividing an image to be rendered into a first image part and a second image part; and
rendering said first image part by said first graphics card and rendering said second image part by said second graphics card.

19. The method of claim 18, further comprising:
said second graphics card sending a rendered second image part to said first graphics card.

20. The method of claim 19, further comprising:
said first graphics card combining a rendered first image part with said rendered second image part to generate a combined image.
